(19) United States
(12) Patent Application Publication
(10) Pub. No.: US 2024/0162488 A1
(43) Pub. Date: May 16, 2024

(54) SOLID ELECTROLYTE FOR LI-ION BATTERY

(71) Applicant: Arkema France, Colombes (FR)

(72) Inventors: Gerome GODILLOT, Lacq (FR); Christophe NAVARRO, Lacq (FR); Christine TARISSE, Lacq (FR)

(21) Appl. No.: 18/284,563

(22) PCT Filed: Apr. 5, 2022
(86) PCT No.: PCT/FR2022/050632

§ 371 Date: Sep. 28, 2023

(30) Foreign Application Priority Data
Apr. 9, 2021 (FR) FR2103647

(51) Int. Cl. H01M 10/0565; H01M 10/0525; H01M 50/403; H01M 50/411; H01M 50/497

(52) U.S. Cl. CPC H01M 10/0565; H01M 10/0525; H01M 50/403; H01M 50/411; H01M 50/497; H01M 2300/0082

(57) ABSTRACT

The invention relates to a composition of a solid electrolyte which makes possible the manufacture of a film exhibiting a very good compromise between ion conductivity, electrochemical stability, high-temperature stability and mechanical strength. This film is intended for a separator application, in particular for Li-ion batteries. The invention also relates to a Li-ion battery comprising such a separator.

### FIELD OF THE INVENTION

The present invention relates generally to the field of electrical energy storage in the storage batteries of Li-ion type. More specifically, the invention relates to a composition of a solid electrolyte which makes possible the manufacture of a film exhibiting a very good compromise between ion conductivity, electrochemical stability, high-temperature stability and mechanical strength. This film is intended for a separator application, in particular for Li-ion batteries. The invention also relates to a Li-ion battery comprising such a separator.

### TECHNICAL BACKGROUND

A Li-ion battery includes at least one negative electrode or anode coupled to a copper current collector, a positive electrode or cathode coupled to an aluminium current collector, a separator and an electrolyte. The electrolyte consists of a lithium salt, generally lithium hexafluorophosphate, mixed with a solvent which is a mixture of organic carbonates, which are chosen in order to optimize the transportation and the dissociation of the ions. A high dielectric constant promotes the dissociation of the ions, and thus the number of ions available in a given volume, while a low viscosity promotes the ionic diffusion which plays an essential role, among other parameters, in the rates of charge and discharge of the electrochemical system.

Rechargeable or storage batteries are more advantageous than primary batteries (which are not rechargeable) because the associated electrochemical reactions taking place at the positive and negative electrodes of the battery are reversible. The electrodes of the storage cells can be regenerated several times by the application of an electric current. Many advanced electrode systems have been developed for storing electrical energy. In parallel, great efforts have been devoted to developing electrolytes capable of improving the capacities of electrochemical cells.

Located between the two electrodes, the separator acts as mechanical and electronic barrier and as ion conductor. Several categories of separators exist: dry polymer membranes, gelled polymer membranes and micro- or macroporous separators impregnated with liquid electrolyte.

The separator market is dominated by the use of polyolefins (Celgard® or Hipore®) produced by extrusion and/or drawing. Separators have to simultaneously exhibit low thicknesses, an optimum affinity for the electrolyte and a satisfactory mechanical strength. Among the most advantageous alternatives to polyolefins, polymers exhibiting a better affinity with regard to standard electrolytes have been proposed, in order to reduce the internal resistances of the system, such as poly(methyl methacrylate) (PMMA), poly(vinylidene fluoride) (PVDF) and poly(vinylidene fluoride-co-hexafluoropropene) (P(VDF-co-HFP)).

The liquid electrolytes composed of solvent(s), lithium salt(s) and additive(s) have a good ion conductivity but are liable to leak or catch fire if the battery is damaged.

Gelled dense membranes constitute an alternative to separators impregnated with liquid electrolyte. The term “dense membranes” refers to membranes which no longer have any free porosity. They are swollen by the solvent but the latter, tightly bonded chemically to the membrane material, has lost all its solvating properties: the solvent then passes through the membrane without entraining solute. In the case of these membranes, the free spaces correspond to those left between them by the polymer chains and have the size of simple organic molecules or hydrated ions. However, the disadvantage of gelled membranes is that of not retaining a mechanical strength after swelling sufficient to make possible easy handling of the separator for the manufacture of the cell and to withstand the mechanical stresses during the charging/discharging cycles of the battery.

The use of solid electrolytes makes it possible to overcome these difficulties, while avoiding the use of flammable liquid components. A further advantage of solid or virtually solid electrolytes is to make possible the use of lithium metal at the negative electrode, preventing the formation of dendrites which can cause short-circuits during the cycling. The use of lithium metal makes possible a saving in energy density in comparison with negative insertion or alloy electrodes.

However, solid electrolytes are generally less conductive than liquid electrolytes. The difficulty for solid electrolytes is to reconcile a high ion conductivity, a good electrochemical stability and also a satisfactory temperature stability. The ion conductivity has to be equivalent to that of the liquid electrolytes (of the order of 1 mS/cm at 25° C., measured by electrochemical impedance spectroscopy).

The electrochemical stability has to make possible the use of the electrolyte with cathode materials which can operate at high voltage (>4.5 V). Likewise, the solid electrolyte has to operate at least up to 80° C. and not catch fire below 130° C.

Poly(vinylidene fluoride) (PVDF) and its derivatives exhibit an advantage as main constituent material of the separator for their electrochemical stability and for their high dielectric constant, which promotes the dissociation of the ions and thus the conductivity. The copolymer P(VDF-HFP) (copolymer of vinylidene fluoride (VDF) and of hexafluoropropylene (HFP)) has been studied as gelled membrane because it exhibits a lower crystallinity than PVDF. For this reason, the advantage of these P(VDF-HFP) copolymers is that they make it possible to achieve greater swellings and to thus promote the conductivity.

The document U.S. Pat. No. 5,296,318 describes compositions of solid electrolytes comprising a mixture of P(VDF-co-HFP) copolymer, of lithium salt and of compatible solvent having a moderate boiling point (i.e. of between 100° C. and 150° C.), which are capable of forming an extendable and self-supporting film. Example 2 describes the preparation of a film having a thickness of 100 μm from a composition containing a P(VDF-HFP) copolymer, LiPF₆ (lithium hexafluorophosphate) and a mixture of ethylene carbonate and propylene carbonate.

There still exists a need to develop novel solid electrolytes which exhibit a good compromise between ion conductivity, electrochemical stability and temperature stability, and which are suitable for a simplified use compatible with an industrial application.

It is thus an aim of the invention to overcome at least one of the disadvantages of the prior art, namely to provide a solid electrolyte composition exhibiting performance qualities at least equivalent to those of a liquid electrolyte.

The invention also relates to a polymeric film consisting of said composition exhibiting good properties of mechanical strength, of ion conductivity and of electrochemical stability.

The invention is also targeted at providing at least one process for the manufacture of this polymeric film.

Another subject matter of the invention is a separator, in particular for a Li-ion storage battery, consisting, in all or part, of said film. This separator can also be used in a battery, a capacitor, an electrochemical double layer capacitor, a membrane-electrode assembly (MEA) for a fuel cell or an electrochromic device.

Finally, the invention is targeted at providing rechargeable Li-ion storage batteries comprising such a separator.

### SUMMARY OF THE INVENTION

The invention relates first to a solid electrolyte composition consisting of:
a) at least one copolymer of vinylidene fluoride (VDF) and of at least one comonomer compatible with VDF,
b) a mixture of at least one ionic liquid and of at least one plasticizer, and
c) at least one lithium salt.

The term “comonomer compatible with VDF” is understood to mean a comonomer which can polymerize with VDF; these monomers are preferably chosen from vinyl fluoride, trifluoroethylene, chlorotrifluoroethylene (CTFE), 1,2-difluoroethylene, tetrafluoroethylene (TFE), hexafluoropropylene (HFP) or perfluoro(alkyl vinyl) ethers, such as perfluoro(methyl vinyl) ether (PMVE), perfluoro(ethyl vinyl) ether (PEVE) or perfluoro(propyl vinyl) ether (PPVE).

According to one embodiment, the VDF copolymer is a terpolymer.

According to one embodiment, the component a) is at least a copolymer of vinylidene fluoride (VDF) and of hexafluoropropylene (HFP), or P(VDF-HFP).

Advantageously, said P(VDF-HFP) copolymer has a content by weight of HFP of greater than or equal to 5% and less than or equal to 45%.

According to one embodiment, in said mixture of ionic liquid and of plasticizer, said plasticizer exhibits a high boiling point (greater than 150° C.).

According to one embodiment, said lithium salt is chosen from the list: LiFSI, LiTFSI, LiTDI, LiPF₆, LiBF₄ and LiBOB.

The invention also relates to a non-porous film consisting of said solid electrolyte composition. Advantageously, the film does not contain solvent and exhibits a high ion conductivity.

Another subject matter of the invention is a separator, in particular for a rechargeable Li-ion battery, comprising a film as described.

The invention also relates to an electrochemical device chosen from the group: batteries, capacitor, electrochemical double layer electrical capacitor, and membrane-electrode assembly (MEA) for a fuel cell or an electrochromic device, said device comprising a separator as described.

Another subject matter of the invention is a lithium-based storage battery, for example a Li-ion battery, or Li—S or Li-air batteries, comprising a negative electrode, a positive electrode and a separator, in which said separator comprises a film as described.

The present invention makes it possible to overcome the disadvantages of the state of the art. It more particularly provides a film capable of operating as separator which combines a high ion conductivity, good electrochemical stability, temperature stability and a mechanical strength sufficient to make possible easy handling of the separator.

The advantage of this invention is to offer a better guarantee of safety in comparison with a separator based on liquid electrolyte, for electrochemical performance qualities at least equal to those of the liquid electrolytes. There is thus no possible escape of electrolyte and the flammability of the electrolyte is greatly reduced thereby.

Just like the liquid electrolytes, the solid electrolyte according to the invention can be used in a battery with a graphite, silicon or graphite and silicon anode. However, its resistance to the growth of dendrites at the surface of the anode also authorizes a lithium metal anode, which makes possible a saving in energy density in comparison with conventional Li-ion technologies.

### BRIEF DESCRIPTION OF THE FIGURES

FIG. 1 is a diagram representing the electrochemical stability of different solid electrolyte compositions, evaluated by cyclic voltammetry.

FIG. 2 is a diagram representing the performance qualities of resistance to dendrites of a solid electrolyte composition, evaluated by causing lithium ions to move through a film placed between two lithium metal electrodes.

### DESCRIPTION OF EMBODIMENTS OF THE INVENTION

The invention is now described in more detail and in a nonlimiting way in the description which follows.

According to a first aspect, the invention relates to a solid electrolyte composition consisting of:
a) at least one copolymer of VDF and of at least one comonomer compatible with VDF,
b) a mixture of at least one ionic liquid and of at least one plasticizer, and
c) at least one lithium salt.

According to various implementations, said film comprises the following features, if appropriate combined. The contents indicated are expressed by weight, unless otherwise indicated. The concentration ranges indicated comprise the limits, unless otherwise indicated.

Component a)

Component a) consists of at least one copolymer comprising units of vinylidene difluoride (VDF) and one or more types of units of comonomers compatible with vinylidene difluoride (hereinafter referred to as “VDF copolymer”). The VDF copolymer contains at least 50% by weight of vinylidene difluoride, advantageously at least 70% by weight of VDF and preferably at least 80% by weight of VDF.

The comonomers compatible with vinylidene difluoride can be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluoroalkyl vinyl ethers and in particular those of general formula Rf—O—CF═CF₂, Rf being an alkyl group, preferably a C₁ to C₄ alkyl group (preferred examples being perfluoropropyl vinyl ether and perfluoromethyl vinyl ether). The fluorinated monomer can comprise a chlorine or bromine atom. It can in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

According to one embodiment, the component a) consists of a VDF copolymer.

According to one embodiment, the component a) consists of a P(VDF-HFP) copolymer.

According to one embodiment, the component a) consists of a mixture of a vinylidene fluoride homopolymer (PVDF) and of at least one VDF copolymer, with a content by weight of PVDF homopolymer ranging from 0.1% to 20%, based on the weight of said mixture.

According to one embodiment, said component a) consists of a mixture of a PVDF homopolymer and of a P(VDF-HFP) copolymer.

According to one embodiment, said component a) consists of a mixture of two VDF copolymers with different structures.

Advantageously, the P(VDF-HFP) copolymer has a content by weight of HFP of greater than or equal to 5%, preferably of greater than or equal to 8%, advantageously of greater than or equal to 11%, and less than or equal to 45%, preferably of less than or equal to 30%.

According to one embodiment, the VDF copolymer and/or the PVDF homopolymer comprises monomer units bearing at least one of the following functions: carboxylic acid, carboxylic acid anhydride, carboxylic acid ester, epoxy groups (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluorinated monomer with a monomer bearing at least one of said functional groups and a vinyl function capable of copolymerizing with the fluorinated monomer, according to techniques well known to a person skilled in the art.

According to one embodiment, the functional group bears a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units bearing the carboxylic acid function additionally comprise a heteroatom chosen from oxygen, sulfur, nitrogen and phosphorus.

The content of functional groups of the VDF copolymer and/or of the PVDF homopolymer is at least 0.01 mol %, preferably at least 0.1 mol %, and at most 15 mol %, preferably at most 10 mol %.

According to one embodiment, the VDF copolymer has a high molecular weight. The term “high molecular weight”, as used here, is understood to mean a copolymer having a melt viscosity of greater than 100 Pa·s, preferably of greater than 500 Pa·s, more preferably of greater than 1000 Pa·s, according to the ASTM D-3835 method, measured at 232° C. and 100 sec⁻¹.

The VDF copolymers used in the invention can be obtained by known polymerization methods, such as emulsion, solution or suspension polymerization.

According to one embodiment, they are prepared by an emulsion polymerization process in the absence of a fluorinated surface-active agent.

According to one embodiment, said VDF copolymer is a random copolymer. This type of copolymer exhibits the advantage of exhibiting a uniform distribution of the comonomer along the vinylidene fluoride chains.

According to one embodiment, said VDF copolymer is a “heterogeneous” copolymer which is characterized by a non-homogeneous distribution of the comonomer along the VDF chains, due to the process of synthesis described by the Applicant Company for example in the document U.S. Pat. No. 6,187,885 or in the document U.S. Pat. No. 10,570,230. A heterogeneous copolymer possesses two (or more) distinct phases, with a phase rich in PVDF homopolymer and a comonomer-rich copolymer phase.

According to one embodiment, the heterogeneous copolymer consists of noncontinuous, discrete and individual copolymer domains of comonomer-rich phase, which are distributed homogeneously in a PVDF-rich continuous phase. The term “a non-continuous structure” is then used.

According to another embodiment, the heterogeneous copolymer is a copolymer having two (or more) continuous phases which are intimately bonded together and cannot be physically separated. The term “a co-continuous structure” is then used.

According to one embodiment, said heterogeneous copolymer comprises two or more co-continuous phases which comprise:
a) from 25% to 50% by weight of a first co-continuous phase comprising 90-100% by weight of vinylidene fluoride monomer units and 0% to 10% by weight of other fluoromonomer units, and
b) from more than 50% by weight to 75% by weight of a second co-continuous phase comprising from 65% to 95% by weight of vinylidene fluoride monomer units and an effective amount of one or more comonomers, such as hexafluoropropylene and perfluorovinyl ether, to bring about the phase separation of the second co-continuous phase from the first co-continuous phase.

The heterogeneous copolymer can be manufactured by forming an initial polymer which is rich in VDF monomer units, generally greater than 90% by weight of VDF, preferably greater than 95% by weight, and in a preferred embodiment a PVDF homopolymer, and by then adding a comonomer to the reactor at a well-advanced point of the polymerization in order to produce a copolymer. The polymer and the copolymer which are rich in VDF will form distinct phases, which will give an intimate heterogeneous copolymer.

The copolymerization of VDF with a comonomer, for example with HFP, results in a latex generally having a solids content of from 10% to 60% by weight, preferably from 10% to 50%, and having a weight-average particle size of less than 1 micrometre, preferably of less than 800 nm and more preferably of less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometres and preferably from 2 to 10 micrometres. The agglomerates can break up into discrete particles during the formulation and the application to a substrate.

The VDF copolymers used in the invention can form a gradient between the core and the surface of the particles, in terms of composition (content of comonomer, for example) and/or of molecular weight.

According to some embodiments, the VDF copolymers contain biobased VDF. The term “biobased” means “resulting from biomass”. This makes it possible to improve the ecological footprint of the membrane. Biobased VDF can be characterized by a content of renewable carbon, that is to say of carbon of natural origin and originating from a biomaterial or from biomass, of at least 1 atom %, as determined by the content of 14 C according to Standard NF EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

Component b)

The second component of the solid electrolyte composition of the invention is a mixture of at least one ionic liquid and of at least one plasticizer.

An ionic liquid is a liquid salt at ambient temperature, that is to say that it has a melting point of less than 100° C. under atmospheric pressure. It is formed by the combination of an organic cation and of an anion, the ionic interactions of which are sufficiently weak not to form a solid.

Mention may be made, as examples of organic cations, of the cations ammonium, sulfonium, pyridinium, pyrrolidinium, imidazolium, imidazolinium, phosphonium, guanidinium, piperidinium, thiazolium, triazolium, oxazolium, pyrazolium and their mixtures. According to one embodiment, this cation can comprise a C₁-C₃₀ alkyl group, such as 1-butyl-1-methylpyrrolidinium, 1-ethyl-3-methylimidazolium, N-methyl-N-propylpyrrolidinium or N-methyl-N-butylpiperidinium.

According to one embodiment, the anions which are combined with them are chosen from: imides, in particular bis(fluorosulfonyl)imide and bis(trifluoromethanesulfonyl)imide; borates; phosphates; phosphinates and phosphonates, in particular alkylphosphonates; amides, in particular dicyanamide; aluminates, in particular tetrachloroaluminate; halides (such as bromide, chloride or iodide anions); cyanates; acetates (CH₃COO⁻), in particular trifluoroacetate; sulfonates, in particular methanesulfonate (CH₃SO₃⁻) or trifluoromethanesulfonate; and sulfates, in particular hydrogen sulfate.

According to one embodiment, the anions are chosen from tetrafluoroborate (BF₄⁻), bis(oxalato)borate (BOB⁻), hexafluorophosphate (PF₆⁻), hexafluoroarsenate (AsF₆⁻), triflate or trifluoromethylsulfonate (CF₃SO₃⁻), bis(fluorosulfonyl)imide (FSI⁻), bis(trifluoromethanesulfonyl)imide (TFSI⁻), nitrate (NO₃⁻) and 4,5-dicyano-2-(trifluoromethyl)imidazole (TDI⁻).

According to one embodiment, said anion of the ionic liquid is chosen from TDI⁻, FSI⁻, TFSI⁻, PF₆⁻, BF₄⁻, NO₃⁻ and BOB⁻.

According to one embodiment, said anion of the ionic liquid is FSI⁻.

The component b) of the solid electrolyte composition of the invention also contains a plasticizer.

Advantageously, the plasticizer is a solvent having a high boiling point (of greater than 150° C.). According to one embodiment, the plasticizer is chosen from:
vinylene carbonate (VC) (CAS: 872-36-6),
fluoroethylene carbonate or 4-fluoro-1,3-dioxolan-2-one (FEC or F1EC) (CAS: 114435-02-8),
trans-4,5-difluoro-1,3-dioxolan-2-one (F2EC) (CAS: 171730-81-7),
ethylene carbonate (EC) (CAS: 96-49-1),
propylene carbonate (PC) (CAS: 108-32-7),
(2-cyanoethyl)triethoxysilane (CAS: 919-31-3),
3-methoxypropionitrile (CAS No. 110-67-8),
ethers, such as polyethylene glycol dimethyl ethers, in particular diethylene glycol dimethyl ether (EG2DME), triethylene glycol dimethyl ether (EG3DME) and tetraethylene glycol dimethyl ether (EG4DME).

The mixtures of at least one ionic liquid and of at least one plasticizer make it possible to obtain improved properties of conductivity, electrochemical stability, thermal stability, compatibility with electrodes, retention of capacity, in comparison with conventional liquid electrolytes.

Examples of component b) according to the invention are the following mixtures:
1-ethyl-3-methylimidazolium-FSI and FEC,
1-ethyl-3-methylimidazolium-FSI and tetraethylene glycol dimethyl ether,
1-butyl-1-methylpyrrolidinium-FSI and FEC,
1-ethyl-3-methylimidazolium-TFSI and FEC.

According to one embodiment, in the mixture, the ratio by weight of the ionic liquids to the plasticizers forming the component b) varies from 0.1 to 10.

Component c)

The lithium salt present in the solid electrolyte composition comprises the same anion as those of the ionic liquid present in component b).

According to one embodiment, said lithium salt is chosen from: LiPF₆, LiFSI, LiTFSI, LiTDI, LiBF₄, LiNO₃ and LiBOB.

According to one embodiment, the solid electrolyte composition consists of:
a) from 20% to 70% of VDF copolymers(s),
b) from 10% to 80% of ionic liquid(s)/plasticizer(s) mixture, and
c) from 2% to 30% of lithium salt(s),
the sum of all the constituents being 100%.

According to one embodiment, the solid electrolyte composition consists of:
from 30% to 50% of component a),
from 40% to 70% of component b), and
from 3% to 10% of component c).

According to one embodiment, the solid electrolyte composition consists of a P(VDF-HFP) copolymer, an EMIM-FSI/EG4DME mixture and LiFSI in proportions by weight of 40/56/4, the ionic liquid/plasticizer ratio by weight being 1:1.

The invention also relates to a non-porous film consisting of said solid electrolyte composition. Advantageously, the film does not contain solvent and exhibits a high ion conductivity. Advantageously, the film is self-supported, that is to say that it can be handled without the help of a support. Advantageously, the film is capable of being wound, that is to say that it can be handled so that it can be wound onto a reel.

According to one embodiment, said film exhibits a thickness of 5 μm to 30 μm, preferably of 7 μm to 20 μm.

According to one embodiment, the film according to the invention exhibits an ion conductivity ranging from 0.01 to 5 mS/cm, preferably from 0.05 to 5 mS/cm, advantageously from 0.5 to 5 mS/cm, at 25° C. The conductivity is measured by electrochemical impedance spectroscopy. According to one embodiment, the non-porous film is placed between two gold electrodes in a leaktight conductivity cell and under an inert atmosphere (CESH, Biologic) and electrochemical impedance spectroscopy is carried out between 1 Hz and 1 MHz with an amplitude of 10 mV. The resistance R of the film is subsequently determined by linear regression of the curve −Im(Z)=f (Re(Z)). The conductivity a is then given by the following relationship:

$$σ = \frac{l}{R \times S}$$

where l is the thickness of the film and S its surface area. For each composition, the conductivity value at a given temperature is obtained by taking the mean over at least two measurements carried out on different samples.

Advantageously, the film according to the invention exhibits good electrochemical stability over the temperature range extending from −20° C. to 80° C.

Advantageously, the film according to the invention exhibits a content of solvent(s) having a boiling point of less than 150° C. of less than 1% by weight, preferably of less than 0.1%, preferably of less than 10 ppm.

Advantageously, the film retains its properties up to 80° C. and does not catch fire below 130° C.

According to one embodiment, the film according to the invention exhibits a mechanical strength characterized by an elastic modulus, measured at 1 Hz and 23° C. by dynamic mechanical analysis, of greater than 0.1 MPa, preferentially of greater than 1 MPa.

The invention is also targeted at providing at least one process for the manufacture of this polymeric film.

According to one embodiment, said fluorinated polymer film is manufactured by a solvent-route process. Said at least one VDF copolymer is dissolved at ambient temperature in a solvent chosen from: N-methyl-2-pyrrolidone, dimethyl sulfoxide, dimethylformamide, methyl ethyl ketone, acetonitrile and acetone. Said at least one lithium salt is dissolved in the ionic liquid/plasticizer mixture, in order to obtain a lithium salt solution. The two solutions are mixed. The mixture obtained is then deposited on a support (for example a glass sheet) and dried at 60° C. under vacuum overnight. A perfectly homogeneous and transparent self-supported film is finally obtained.

According to one embodiment, said fluorinated polymer film is manufactured by extrusion. The VDF copolymer and the plasticizer are mixed at ambient temperature. This mixture is introduced into an extruder brought to 100-150° C. The lithium salt dissolved in the ionic liquid is subsequently added. After homogenization, the mixture is extruded through a flat die with a thickness of 300 μm. The thickness is adjusted to the desired value by drawing the film.

According to one embodiment, said fluorinated polymer film is manufactured by hot pressing. The VDF copolymer(s), ionic liquid(s), plasticizer(s) and lithium salt(s) mixture is homogenized and then deposited between the two metal plates of a hot press. A pressure of from to 10 kN is subsequently applied at 100-150° C. for from 1 to 5 min in order to obtain a film. The film obtained is subsequently cooled to ambient temperature.

Another subject matter of the invention is a separator for a Li-ion storage battery consisting, in all or part, of said film.

The invention also relates to an electrochemical device chosen from the group: batteries, capacitor, electrochemical double layer electrical capacitor, and membrane-electrode assembly (MEA) for a fuel cell or an electrochromic device, said device comprising a separator as described.

Another subject matter of the invention is a lithium-based storage battery, for example a Li-ion battery, or Li—S or Li-air batteries, comprising a negative electrode, a positive electrode and a separator, in which said separator comprises a film as described above.

According to one embodiment, said battery comprises a lithium metal anode.

### EXAMPLES

The following examples non-limitingly illustrate the scope of the invention.

1. Preparation of a Solid Electrolyte for a Li-Ion Battery Separator by the Solvent Route

0.4 g of P(VDF-HFP) (poly(vinylidene fluoride)-co-hexafluoropropylene) (containing 11% of HFP by weight) is dissolved in 1.93 g of acetone at ambient temperature. Furthermore, 0.056 g of LiFSI (lithium bis(fluorosulfonyl)imide) is dissolved in 0.276 g of EMIM-FSI (1-ethyl-3-methylimidazolium bis(fluorosulfonyl)imide) and 0.281 g of FEC (fluoroethylene carbonate). The latter solution is added to the P(VDF-HFP) solution and then mixed. The solution obtained is then deposited in the form of a film using a doctor blade and dried at 60° C. under vacuum overnight. A transparent self-supported film of 15-20 μm is finally obtained.

The residual solvent is measured by GC-MS. The amount of acetone is less than the detection limit of this technique, i.e. 10 ppm.

2. Preparation of a Solid Electrolyte for a Li-Ion Battery Separator by Extrusion

A mixture of 5.7 g of P(VDF-HFP) (containing 15% of HFP by weight) and 4 g of EG4DME (tetraethylene glycol dimethyl ether) is prepared, which mixture is introduced into a 15 ml microextruder (with recirculation of the substance) heated to 100-150° C. A mixture of 0.57 g of LiFSI dissolved in 4 g of EMIM-FSI is subsequently added. The mixture is homogenized and then a rod is extruded, which rod is pressed at 120° C. A transparent self-supported film of approximately 30 μm is then obtained.

3. Measurement of the Conductivity of a Completely Solid Separator

The conductivity is evaluated by electrochemical impedance spectroscopy by placing the solid electrolyte (prepared by the solvent route under an inert atmosphere) between the two gold electrodes of a leaktight conductivity cell and under an inert atmosphere (CESH, Biologic). Measurements are carried out on films composed of 40% by weight of P(VDF-HFP) (containing 11% by weight of HFP) and different contents of ionic liquid and plasticizer. The content of lithium salt (LiFSI) in the solid electrolyte is such that its concentration in the ionic liquid+plasticizer mixture is equal to 0.4 mol/1. Different plasticizers are also evaluated, such as FEC (fluoroethylene carbonate), EG2DME (diethylene glycol dimethyl ether), EG3DME (triethylene glycol dimethyl ether), EG4DME (tetraethylene glycol dimethyl ether) or MPN (3-methoxypropionitrile). The results are shown in Table 1; the compositions are as percentages by weight.

TABLE 1

| | Nature of | P(VDF- | Ionic | | | Conductivity |
|---|---|---|---|---|---|---|
| Compo- | the | HFP) | liquid | Plasticizer | LiFSI | at 25° C. |
| sition | plasticizer | (%) | (%) | (%) | (%) | (mS/cm) |
| 1 | | 93 | | | 7 | 2.3 × 10⁻⁹ |
| 2 | FEC | 40 | 43 | 14 | 3 | 0.91 |
| 3 | FEC | 40 | 28 | 28 | 4 | 0.25 |
| 4 | FEC | 40 | 14 | 43 | 3 | 0.01 |
| 5 | FEC | 40 | | 57 | 3 | 2.7 × 10⁻⁴ |
| 6 | EG2DME | 40 | 28 | 28 | 4 | 0.11 |
| 7 | EG3DME | 40 | 28 | 28 | 4 | 0.30 |
| 8 | EG4DME | 40 | 28 | 28 | 4 | 1.24 |
| 9 | MPN | 40 | 28 | 28 | 4 | 0.27 |

Composition 1 shows that the mixture of P(VDF-HFP) and of lithium salt does not make it possible to have a sufficient conductivity. A mixture of ionic liquid and of plasticizer has to be added to this mixture. The solid electrolytes thus prepared (Compositions 2 to 9) exhibit high ion conductivities (up to 1.2 mS/cm), of the same order of magnitude as the liquid electrolytes. In Compositions 2 to 5, the ratio by weight of the ionic liquid to the plasticizer is varied. The results show that this ratio has to be greater than 0 in order to obtain a good conductivity, which means that the presence of ionic liquid is essential. It is also observed that the ion conductivity increases with the content of ionic liquid. This characteristic thus makes it possible, by varying the composition of the film, to finely adjust the conduction properties of the solid electrolyte depending on the application targeted. At iso composition, higher ion conductivities are obtained with the plasticizer EG4DME.

4. Measurement of the Electrochemical Stability of a Completely Solid Separator

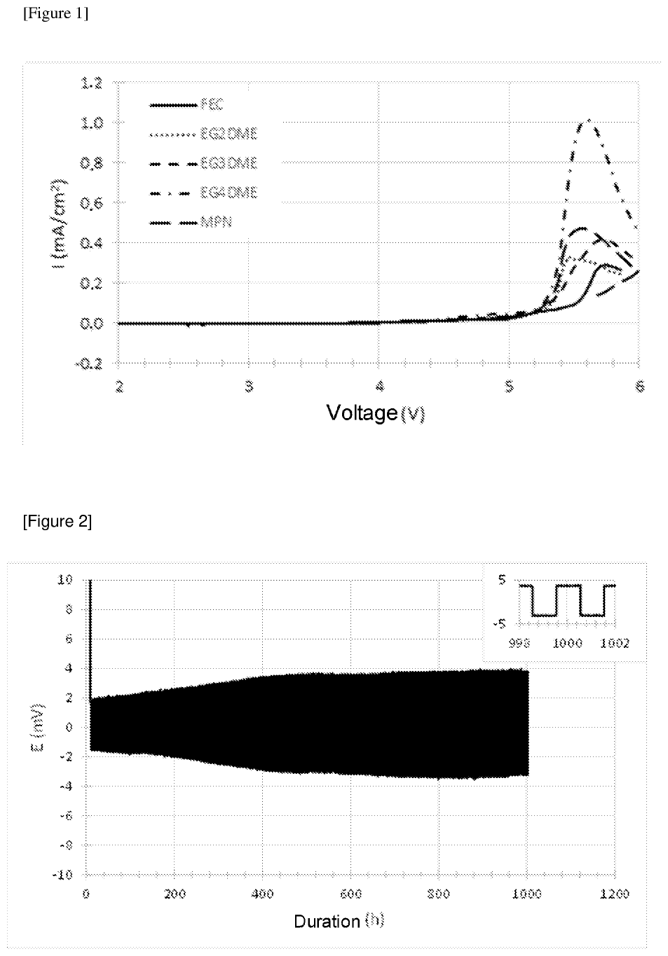

The electrochemical stability of different solid electrolytes is evaluated by cyclic voltammetry at 60° C. by placing the solid electrolyte (prepared by the solvent route under an inert atmosphere) in a button cell between a stainless steel electrode and a lithium metal electrode. Cyclic voltammetry is carried out between 2 and 6 V at 1 mV/s. The results are presented in FIG. 1.

It is observed that the film with the plasticizer EG4DME has an electrochemical stability of at least 4.6 V, whereas that of the other films is at least equal to 4.8 V. These electrochemical stabilities are amply sufficient for use in Li-ion batteries, including with high-voltage positive active substances (nickel-rich NMC type).

5. Measurement of the Thermal Stability of a Completely Solid Separator

In order to confirm that the properties of the completely solid separator have not deteriorated at least up to 80° C., ion conductivity measurements as described in Example 3 are carried out. After introduction of the solid electrolyte into the CESH cell, a first conductivity measurement is carried out at 25° C. (Measurement 1). The CESH cell is subsequently gradually heated up to 80° C. and maintained at 80° C. for 1 hour. The temperature is then gradually lowered down to 25° C. and a second conductivity measurement is carried out at 25° C. (Measurement 2). The results are presented in Table 2; the compositions are as percentages by weight.

TABLE 2

| | Measurement 1 | Measurement 2 |
|---|---|---|
| Composition of the solid electrolyte | at 25° C. (mS/cm) | at 25° C. (mS/cm) |
| P(VDF-HFP)/EMIM-FSI/FEC/LIFSI (40/43/14/3) | 0.75 | 0.91 |
| P(VDF-HFP)/EMIM-FSI/FEC/LIFSI (40/28/28/4) | 0.14 | 0.25 |
| P(VDF-HFP)/EMIM-FSI/FEC/LIFSI (40/14/43/3) | 0.009 | 0.010 |
| P(VDF-HFP)/EMIM-FSI/EG2DME/LIFSI (40/28/28/4) | 0.08 | 0.11 |
| P(VDF-HFP)/EMIM-FSI/EG3DME/LIFSI (40/28/28/4) | 0.19 | 0.30 |
| P(VDF-HFP)/EMIM-FSI/EG4DME/LIFSI (40/28/28/4) | 1.10 | 1.24 |
| P(VDF-HFP)/EMIM-FSI/MPN/LIFSI (40/28/28/4) | 0.19 | 0.27 |

After a period of 1 hour at 80° C., a decrease in the ion conductivity at 25° C. is not observed for the group of the solid electrolytes tested. On the contrary, the ion conductivity substantially increases, by virtue of the improvement in the interfaces between the solid electrolyte and the gold electrode which takes place at around 80° C.

6. Test of Resistance to Dendrites of a Completely Solid Separator

The resistance to dendrites is evaluated by chronopotentiometry at 25° C. by placing the solid electrolyte (prepared under an inert atmosphere) in a button cell between two lithium metal electrodes. “Plating/stripping” cycles are carried out on the lithium by applying a current density of 3 mA/cm 2 for 1 h, then −3 mA/cm 2 for 1 h, and so on. The results obtained with a film having the composition P(VDF-HFP)/EMIM-FSI/EG4DME/LiFSI (40/28/28/4) are presented in FIG. 2. The overvoltage observed is low (of the order of 3-4 mV) and stable, and no dendrite formation is observed during 1000 h.

1. A solid electrolyte composition consisting of:
a) at least one copolymer of vinylidene fluoride (VDF) and of at least one comonomer compatible with VDF, said VDF copolymer comprising at least 50% by weight of VDF,
b) a mixture of at least one ionic liquid and of at least one plasticizer, and
c) at least one lithium salt.

2. The solid electrolyte composition of claim 1, wherein said comonomer is selected from the group consisting of vinyl fluoride, trifluoroethylene, chlorotrifluoroethylene, 1,2-difluoroethylene, tetrafluoroethylene, hexafluoropropylene, perfluoro(methyl vinyl) ether, perfluoro(ethyl vinyl) ether and perfluoro(propyl vinyl) ether.

3. The solid electrolyte composition of claim 1, wherein said VDF copolymer is a copolymer of vinylidene fluoride and hexafluoropropylene (HFP) having a content by weight of HFP of greater than or equal to 5% and less than or equal to 45%.

4. The solid electrolyte composition of claim 1, wherein said ionic liquid comprises an anion selected from the group consisting of tetrafluoroborate (BF₄⁻), bis(oxalato)borate (BOB⁻), hexafluorophosphate (PF₆⁻), hexafluoroarsenate (AsF₆⁻), triflate or trifluoromethylsulfonate (CF₃SO₃⁻), bis(fluorosulfonyl)imide (FSI⁻), bis(trifluoromethanesulfonyl)imide (TFSI⁻), nitrate (NO₃⁻) and 4,5-dicyano-2-(trifluoromethyl)imidazole (TDI⁻).

5. The solid electrolyte composition of claim 1, wherein said ionic liquid comprises a cation selected from the group consisting of: ammonium, sulfonium, pyridinium, pyrrolidinium, imidazolium, imidazolinium, phosphonium, guanidinium, piperidinium, thiazolium, triazolium, oxazolium, pyrazolium and their mixtures.

6. The solid electrolyte composition of claim 1, wherein said plasticizer is a solvent having a boiling point of greater than 150° C. selected from the group consisting of: vinylene carbonate, fluoroethylene carbonate, trans-4,5-difluoro-1,3-dioxolan-2-one, ethylene carbonate, propylene carbonate, (2-cyanoethyl)triethoxysilane, 3-methoxypropionitrile and polyethylene glycol dimethyl ethers.

7. The solid electrolyte composition of claim 1, wherein said lithium salt is selected from the group consisting of: LiPF₆, LiFSI, LiTFSI, LiTDI, LiBF₄, LiNO₃ and LiBOB.

8. The solid electrolyte composition of claim 1, consisting of:
a) from 20% to 70% of VDF copolymers(s),
b) from 10% to 80% of ionic liquid(s)/plasticizer(s) mixture, and
c) from 2% to 30% of lithium salt(s),
the sum of all the constituents being 100%.

9. A non porous film consisting of the composition of claim 1.

10. The non-porous film of claim 9, exhibiting a content of solvent(s) having a boiling point of less than 150° C. of less than 1% by weight.

11. The non-porous film of claim 9, exhibiting an ion conductivity of from 0.01 to 5 mS/cm at 25° C., measured by electrochemical impedance spectroscopy.

12. A process for the preparation of the non-porous film of claim 9, said process comprising the following stages:
dissolving said at least one VDF copolymer at ambient temperature in a solvent selected from the group consisting of: N-methyl-2-pyrrolidone, dimethyl sulfoxide, dimethylformamide, methyl ethyl ketone, acetonitrile and acetone;
dissolving said at least one lithium salt in an ionic liquid/plasticizer mixture, in order to obtain a lithium salt solution;
mixing the VDF copolymer and lithium salt solutions,
depositing the mixture obtained on a support,
drying at 60° C. under vacuum.

13. A process for the preparation of the non-porous film of claim 9, said process comprising the following stages:
mixing said VDF copolymer and said plasticizer at ambient temperature,
introducing the mixture obtained into an extruder brought to 100-150° C.,
adding the lithium salt dissolved in the ionic liquid, and homogenizing,
extruding the mixture through a flat die with a thickness of 300 μm.

14. A process for the preparation of the non-porous film of claim 9, said process comprising the following stages:
mixing said VDF copolymer(s), ionic liquid(s), plasticizer(s) and lithium salt(s),
homogenizing said mixture,
depositing said mixture between the two metal plates of a hot press,
applying a pressure of from 5 to 10 kN at 100-150° C. for from 1 to 5 min in order to obtain a film,
cooling the film to ambient temperature.

15. A separator for a rechargeable Li-ion battery, comprising the non-porous film of claim 9.

16. An electrochemical device selected from the group consisting of: batteries, capacitor, electrochemical double layer electrical capacitor, and membrane-electrode assembly (MEA) for a fuel cell or an electrochromic device, said electrochemical device comprising the separator of claim 15.

17. A secondary Li-ion battery comprising an anode, a cathode and a separator, wherein said separator comprises the non-porous film of claim 9.
